(19) United States
(12) Patent Application Publication
(10) Pub. No.: US 2025/0076044 A1
(43) Pub. Date: Mar. 6, 2025

(54) METHOD AND DEVICE FOR CALCULATING MUDDING BOUNDARY ELEVATION OF HEADLAND BEACH ADJACENT TO MUDDY SEABED

(71) Applicant: Zhejiang Institute of Hydraulics & Estuary (Zhejiang Institute of Marine Planning and Design), Hangzhou City (CN)

(72) Inventors: Junbao HUANG, Hangzhou City (CN); Haijing LI, Hangzhou City (CN); Xu LIU, Hangzhou City (CN); Wenwei YAO, Hangzhou City (CN)

(21) Appl. No.: 18/669,653

(22) Filed: May 21, 2024

(30) Foreign Application Priority Data
Sep. 6, 2023 (CN) 202311139575.7

(51) Int. Cl. G01C 13/00

(52) U.S. Cl. CPC G01C 13/004

(57) ABSTRACT

The disclosure belongs to the technical fields of coast, ocean engineering and bridge engineering, and provides a method and a device for calculating a mudding boundary elevation of a headland beach adjacent to a muddy seabed. The method includes: obtaining tidal level data, wave data, beach width data and beach height data of the headland beach adjacent to the muddy seabed; according to the above data, calculating a mean high water spring, a mean low water spring, a wave height and a beach slope respectively; and according to the mean high water spring, the mean low water spring, the wave height and the beach slope, calculating the mudding boundary elevation of the beach.

### CROSS-REFERENCE TO RELATED APPLICATIONS

This application claims priority to Chinese Patent Application No. 202311139575.7, filed on Sep. 6, 2023, the contents of which are hereby incorporated by reference.

### TECHNICAL FIELD

The disclosure relates to the technical fields of coastal, ocean engineering and bridge engineering, and in particular to a method and a device for calculating a mudding boundary elevation of a headland beach adjacent to a muddy seabed.

### BACKGROUND

The headland beach on the muddy coast is a precious natural resource, which is rare in the world. However, the beach is common in the coastal areas of Jiangsu, Shanghai and Zhejiang. There is a sand-mud mixing transition zone between the muddy seabed and the headland beach, forming a unique beach dynamic landform system. If the position with a silt clay content exceeding 20% in the sand-mud mixing transition zone is set as a mud position, the position of the sand-mud boundary point is one of the most intuitive quantitative indicators of the dynamic geomorphology change of headland beach. The change law of the position of the sand-mud boundary point reflects evolution characteristics of headland beach geomorphology, and is a key link in the design and construction of artificial beach or beach restoration. In recent years, in the process of ecological restoration in coastal zone, many beaches have been artificially restored. It is very important for the operation and maintenance of beaches to predict the muddy position and elevation of beaches after artificial sand laying in the coastal environment with high sediment concentration and strong siltation, which may optimize the beach slope, sand laying range and sand laying thickness.

At present, there is relatively little research on the mudding boundary elevation of the headland beach adjacent to the muddy seabed. Most of the related research abroad is based on the natural composite coast. Due to the regional differences, the research almost does not consider the supply of mud. The natural composite coast is quite different from the sedimentary environment of the domestic composite coast. The research on beach mudding phenomenon in China started late, mostly based on specific cases of sandy beach mudding, and mostly focused on the relationship between sediment initiation and hydrodynamic forces. It is considered that the formation of sand-mud mixed zone is mainly influenced by wave dynamic conditions. At present, there is no convenient and effective calculation method for the mudding boundary elevation of the headland beach adjacent to the muddy seabed in China. In the design stage, there is a need to determine the mudding boundary elevation of the headland beach adjacent to the muddy seabed through special coupled mathematical model of wave current and sediment or physical movable bed model test. However, this process takes a long time, costs a lot, and needs research by professional institutions, which is not conducive to popularization and application in engineering.

### SUMMARY

An objective of the disclosure is to overcome the problems existing in the above background technology, and provide a method and a device for calculating a mudding boundary elevation of a headland beach adjacent to a muddy seabed. The calculation method has strong applicability, simple calculation method and easy operation, and may quickly calculate the mudding boundary elevation of the headland beach adjacent to the muddy seabed.

According to a first aspect of an embodiment of the disclosure, a method for calculating a mudding boundary elevation of a headland beach adjacent to a muddy seabed is provided, including:
S1, obtaining tidal level data, wave data, beach width data and beach height data of the headland beach adjacent to the muddy seabed;
S2, calculating a mean high water spring of the headland beach according to the tidal level data;
S3, calculating a mean low water spring according to the tidal level data;
S4, calculating a wave height according to the wave data;
S5, calculating a beach slope according to the beach width data and the beach height data; and
S6, calculating a mudding boundary elevation of a beach according to the mean high water spring, the mean low water spring, the wave height and the beach slope, and a calculation formula is as follows:

$${H}_{sm} = \frac{{H}_{MHWS} + {H}_{MLWS}}{2} - 0.884 {H}^{1.095} {i}^{- 0.275} - 1.589$$

where Hₛₘ is the mudding boundary elevation of the beach, H_{MHWS} is the mean high water spring, H_{MLWS} is the mean low water spring, H is the wave height, and i is the beach slope.

Optionally, obtaining the tidal level data of the headland beach adjacent to the muddy seabed includes:
when there is long-term measured tidal level series data at a front of the headland beach, using measured tidal level series directly for a statistical calculation to obtain the tidal level data;
when there is no measured tidal level series data, using long-term measured tidal level series data of an adjacent tide station or short-term measured data for the statistical calculation to obtain the tidal level data.

Optionally, obtaining the wave data of the headland beach adjacent to the muddy seabed includes:
when there is long-term measured wave series data at the front of the headland beach, using measured wave series directly for a statistical calculation to obtain the wave data;
when there is no measured wave series data, using measured wave series data of an adjacent wave station or short-term measured data for the statistical calculation to obtain the wave data.

Optionally, calculating the mean high water spring of the headland beach according to the tidal level data includes:
according to the tidal level data, selecting high tidal levels during an astronomical tide period, where the tidal level data is selected from tidal level data of a tide station near the headland beach for at least one whole year, and the astronomical tide period is six days from a second day to a fourth day and from a sixteenth day to an eighteenth day of a lunar calendar; and
calculating an arithmetic mean of the high tidal levels to obtain the mean high water spring.

Optionally, calculating the mean low water spring according to the tidal level data includes:
according to the tidal level data, selecting low tidal levels during the astronomical tide period, where the tidal level data is selected from the tidal level data of the tide station near the headland beach for at least one whole year, and the astronomical tide period is the six days from the second day to the fourth day and from the sixteenth day to the eighteenth day of the lunar calendar; and
calculating an arithmetic mean of the low tidal levels to obtain the mean low water spring.

Optionally, calculating the wave height according to the wave data includes:
according to the wave data, observing waves at every hour with no less than 100 waves each time, and sorting wave height series observed at an hour from large to small, where the wave data is selected from measured wave series at the front of the headland beach or at a nearby wave station for at least one whole year; and
calculating an arithmetic mean of several top wave height series to obtain the wave height.

Optionally, calculating the beach slope according to the beach width data and the beach height data includes:
a calculation formula of the beach slope i is:

$$i = h / b$$

where a beach width b is a length from a back boundary of the beach to an intersection of the beach and a mudflat, and a beach height h is a difference of two topographic elevations.

According to a second aspect of the embodiment of the disclosure, a device for calculating a mudding boundary elevation of a headland beach adjacent to a muddy seabed is provided, including:
an acquisition module used for obtaining tidal level data, wave data, beach width data and beach height data of the headland beach adjacent to the muddy seabed;
a first calculation module used for calculating a mean high water spring of the headland beach according to the tidal level data;
a second calculation module used for a mean low water spring according to the tidal level data;
a third calculation module used for calculating a wave height according to the wave data;
a fourth calculation module used for calculating a beach slope according to the beach width data and the beach height data; and
a fifth calculation module used for calculating a mudding boundary elevation of a beach according to the mean high water spring, the mean low water spring, the wave height and the beach slope, and a calculation formula is as follows:

$${H}_{sm} = \frac{{H}_{MHWS} + {H}_{MLWS}}{2} - 0.884 {H}^{1.095} {i}^{- 0.275} - 1.589$$

where Hₛₘ is the mudding boundary elevation of the beach, H_{MHWS} is the mean high water spring, H_{MLWS} is the mean low water spring, H is the wave height, and i is the beach slope.

According to a third aspect of the embodiment of the disclosure, an electronic device is provided, including:
one or more processors; and
a memory for storing one or more programs.

When the one or more programs are executed by the one or more processors, the one or more processors are caused to realize the method according to the first aspect.

According to the third aspect of the embodiment of the disclosure, a computer-readable storage medium is provided, on which computer instructions are stored. When the instructions are executed by a processor, steps of the method according to the first aspect are realized.

The technical scheme provided by the embodiment of the disclosure may include following beneficial effects.

It may be seen from the above embodiment that the influence of wave action and beach slope is considered in the calculation formula of mudding boundary elevation, so the mudding boundary elevation of the headland beach adjacent to the muddy seabed may be well predicted, and a calculated mudding boundary elevation result is close to a measured result. The disclosure has a significant guiding value in the design, repair and operation and maintenance of the headland beach adjacent to the muddy seabed, and plays a good role in checking and verifying the mudding phenomenon that may occur in the headland beach adjacent to the muddy seabed under construction or built, and has a good application value.

A calculation process of this disclosure is simple, and all parameters are clear and easy to obtain and calculate, so it is convenient for workers to quickly calculate the mudding boundary elevation of the headland beach. Compared with physical model and mathematical model, this disclosure saves time cost and test cost, and is ecomonic.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with this disclosure and together with the description, serve to explain the principles of this disclosure.

FIG. 1 is a flowchart of a method for calculating a mudding boundary elevation of a headland beach adjacent to a muddy seabed according to an exemplary embodiment.

FIG. 2 is a schematic diagram of beach parameters according to an exemplary embodiment.

FIG. 3 is a comparison diagram of calculated results and measured results according to an exemplary embodiment.

FIG. 4 is a block diagram of a device for calculating a mudding boundary elevation of a headland beach adjacent to a muddy seabed according to an exemplary embodiment.

FIG. 5 is a block diagram of an electronic device according to an exemplary embodiment.

### DETAILED DESCRIPTION OF THE EMBODIMENTS

Reference will now be made in detail to exemplary embodiments, examples of which are illustrated in the accompanying drawings. When the following description refers to the drawings, unless otherwise indicated, the same numbers in different drawings indicate the same or similar elements. The embodiments described in the following exemplary embodiments do not represent all embodiments consistent with this disclosure. Rather, they are merely examples of devices and methods consistent with some aspects of the disclosure as detailed in the appended claims.

The terminology used in this disclosure is for the purpose of describing specific embodiments only and is not intended to limit this disclosure. The singular forms “a”, “the” and “this” used in this disclosure and the appended claims are also intended to include the plural forms, unless the context clearly indicates other meaning. It should also be understood that the term “and/or” as used herein refers to and includes any or all possible combinations of one or more associated listed items.

It should be understood that although the terms first, second, third, etc. may be used in this disclosure to describe various information, these information should not be limited to these terms. These terms are only used to distinguish the same type of information from each other. For example, without departing from the scope of this disclosure, the first information may also be called the second information, and similarly, the second information may also be called the first information. Depending on the context, the word “if” as used herein may be interpreted as “at” or “when” or “in response to a determination”.

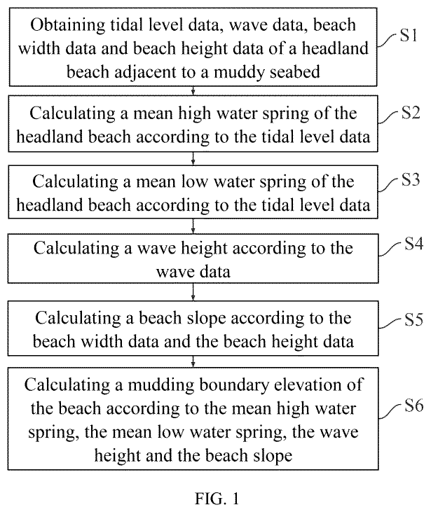

FIG. 1 is a flowchart of a method for calculating a mudding boundary elevation of a headland beach adjacent to a muddy seabed according to an exemplary embodiment. As shown in FIG. 1, the method may include following steps:
S1, obtaining tidal level data, wave data, beach width data and beach height data of the headland beach adjacent to the muddy seabed;
S2, calculating a mean high water spring of the headland beach according to the tidal level data;
S3, calculating a mean low water spring according to the tidal level data;
S4, calculating a wave height according to the wave data;
S5, calculating a beach slope according to the beach width data and the beach height data; and
S6, calculating a mudding boundary elevation of a beach according to the mean high water spring, the mean low water spring, the wave height and the beach slope, and a calculation formula is as follows:

$${H}_{sm} = \frac{{H}_{MHWS} + {H}_{MLWS}}{2} - 0.884 {H}^{1.095} {i}^{- 0.275} - 1.589$$

where Hₛₘ is the mudding boundary elevation of the beach, H_{MHWS} is the mean high water spring, H_{MLWS} is the mean low water spring, H is the wave height, and i is the beach slope.

It may be seen from the above embodiments that the influence of wave action and beach slope is considered in the calculation formula of mudding boundary elevation in this disclosure, and this is the first time to propose the calculation formula of the mudding boundary elevation of the headland beach. The calculation process of the disclosure is simple and convenient, and the calculation result is accurate, so the disclosure is different from the traditional numerical simulation and physical model test with excessive workload. In addition, in the calculation process of the disclosure, charts are not needed, so that human error is reduced.

The specific implementation of the S1 includes: obtaining the tidal level data, the wave data, the beach width data and the beach height data of the headland beach adjacent to the muddy seabed;
specifically, obtaining the tidal level data of the headland beach adjacent to the muddy seabed includes:
A1: when there is long-term measured tidal level series data at a front of the headland beach, using measured tidal level series directly for a statistical calculation to obtain the tidal level data; and
A2: when there is no measured tidal level series data, using long-term measured tidal level series data of an adjacent tide station or short-term measured data for the statistical calculation to obtain the tidal level data.

Among them, obtaining the wave data of the headland beach adjacent to the muddy seabed includes:
B1: when there is long-term measured wave series data at the front of the headland beach, using measured wave series directly for a statistical calculation to obtain the wave data;
B2: when there is no measured wave series data, using measured wave series data of an adjacent wave station or short-term measured data for the statistical calculation to obtain the wave data.

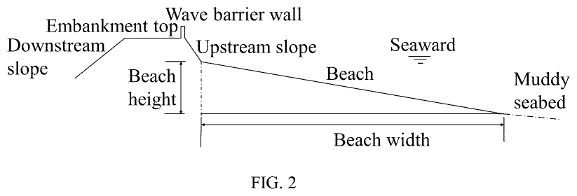

With reference to FIG. 2, the beach width here is a length from a back boundary of the beach to an intersection of the beach and a mudflat, and a beach height is a difference of two topographic elevations. These data may be obtained by reference to Specifications for the Third and Fourth Order Leveling (GB/T 12898-2009), using instruments and equipment such as level and Real Time Kinematic (RTK).

The beach slope is characterized by many factors, such as tidal power, wave power and sediment particle size. On the basis of characterizing the overall scale and the scale of the beach, the beach width and beach height may be directly calculated to obtain the slope. Obtaining these data is an intuitive and important parameter for calculating the mudding boundary elevation.

The specific implementation of the S2 includes: calculating the mean high water spring of the headland beach according to the tidal level data;
specifically, according to the tidal level data, selecting high tidal levels during an astronomical tide period, where the tidal level data is selected from tidal level data of a tide station near the headland beach for at least one whole year, and the astronomical tide period is six days from a second day to a fourth day and from a sixteenth day to an eighteenth day of a lunar calendar; and calculating an arithmetic mean of the high tidal levels to obtain the mean high water spring.

The mean high water spring reflects the upper limit range of tidal action on the beach. It is more statistical and representative to select the tidal level data for at least one whole year in hydrology.

The specific implementation of the S3 includes: calculating the mean low water spring according to the tidal level data;
specifically, according to the tidal level data, selecting low tidal levels during the astronomical tide period, where the tidal level data is selected from the tidal level data of the tide station near the headland beach for at least one whole year, and the astronomical tide period is the six days from the second day to the fourth day and from the sixteenth day to the eighteenth day of the lunar calendar; and calculating an arithmetic mean of the low tidal levels to obtain the mean low water spring.

The mean low water spring reflects the lower limit range of tidal action on the beach. It is more statistical and representative to select the tidal level data for at least one whole year in hydrology.

The specific implementation of the S4 includes: calculating the wave height according to the wave data;
specifically, according to the wave data, observing waves at every hour, with no less than 100 waves each time, and sorting wave height series observed at an hour from large to small, where the wave data is selected from measured wave series at the front of the headland beach or at a nearby wave station for at least one whole year; and calculating an arithmetic mean of several top wave height series to obtain the wave height.

In wave theory, mean of the highest one-tenth of waves (H-one-tenth) is also called significant wave height, which is of great significance to morphological characteristics and geomorphological evolution of beaches. Therefore, without losing generality, in this embodiment, an arithmetic mean of the top one-tenth wave height series is calculated to obtain the H-one-tenth, which is also a common method in the wave theory. In practical application, the wave height may also be replaced by parameters such as average wave height and effective wave height through calculations.

The specific implementation of the S5 includes: calculating the beach slope according to the beach width data and the beach height data;
specifically, a calculation formula of the beach slope i is:

$$i = h / b$$

where a beach width b is a length from a back boundary of the beach to an intersection of the beach and a mudflat, and a beach height h is a difference of two topographic elevations.

Using the beach height h divided by the beach width b to represent the beach slope i has intuitive physical significance, that is, the decrease value of beach height for every 1 meter (m) of beach extension. The beach slope i also affects the degree and range of wave action on the beach.

The specific implementation of the S6 includes: calculating the mudding boundary elevation of the beach according to the mean high water spring, the mean low water spring, the wave height and the beach slope, where the calculation formula is as follows:

$${H}_{sm} = \frac{{H}_{MHWS} + {H}_{MLWS}}{2} - 0.884 {H}^{1.095} {i}^{- 0.275} - 1.589$$

where, Hₛₘ is the mudding boundary elevation of the beach, H_{MHWS} is the mean high water spring, H_{MLWS} is the mean low water spring, Hino is the H-one-tenth, and i is the beach slope.

Usually, waves are the main driving force for the change of beach landforms. The beach slope comprehensively represents the landforms of different beach particle size attributes under the dynamic action, and the tidal level affects the upper limit and the lower limit of the wave action on the beach. Therefore, a more reasonable mudding boundary elevation of the beach may be obtained by comprehensively considering the H-one-tenth representing the wave, the mean high water spring and the mean low water spring representing the tidal level, and the beach slope i representing the beach.

### Embodiment: For 10 Mudding Positions of Headland Beaches

In this embodiment, 10 headland beaches are selected as the implementation objects, and parameters such as mean high water spring, mean low water spring, H-one-tenth and beach slope ratio are listed. Specific implementation groups are shown is Table 1.

TABLE 1

| | | | | | Measured | Calculated |
|---|---|---|---|---|---|---|
| | Mean high | Mean low | H_{1/10} wave | Beach | mudding | mudding |
| | water | water | height in | slope | boundary | boundary |
| | spring | spring | front of | ratio | elevation | elevation |
| Group | H_{MHWS} (m) | H_{MLWS} (m) | beach (m) | iₛᵣ | (m) | (m) |
| 1 | 1.95 | −1.38 | 1.40 | 0.020 | −5.00 | −5.05 |
| 2 | 1.95 | −1.38 | 1.20 | 0.037 | −4.50 | −3.98 |
| 3 | 1.56 | −1.15 | 1.00 | 0.031 | −4.00 | −3.68 |
| 4 | 1.56 | −1.15 | 1.00 | 0.024 | −4.10 | −4.00 |
| 5 | 2.19 | −1.5 | 0.20 | 0.071 | −1.23 | −1.56 |
| 6 | 2.19 | −1.5 | 0.15 | 0.063 | −1.36 | −1.48 |
| 7 | 2.19 | −1.5 | 0.40 | 0.048 | −1.91 | −1.99 |
| 8 | 2.51 | −1.78 | 0.93 | 0.031 | −3.00 | −3.34 |
| 9 | 2.34 | −1.36 | 1.05 | 0.036 | −3.50 | −3.43 |
| 10 | 2.92 | −2.26 | 1.20 | 0.017 | −5.00 | −4.59 |

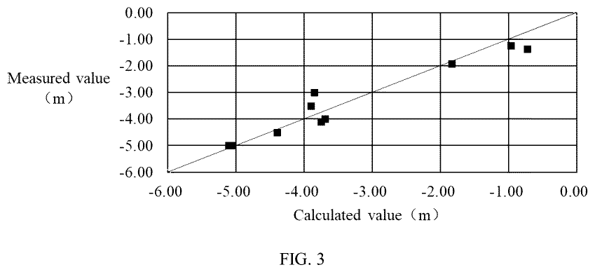

FIG. 3 is a comparison between the calculated results and the measured results. From the figure, it may be seen that the calculated results are close to the measured results, thus indicating that the mudding boundary elevation of the headland beach adjacent to the muddy seabed may be calculated accurately according to the disclosure, so the disclosure is reasonable and reliable in practical application.

Corresponding to the aforementioned embodiment of the method for calculating the mudding boundary elevation of the headland beach adjacent to the muddy seabed, the disclosure also provides an embodiment of a device for calculating a mudding boundary elevation of a headland beach adjacent to a muddy seabed.

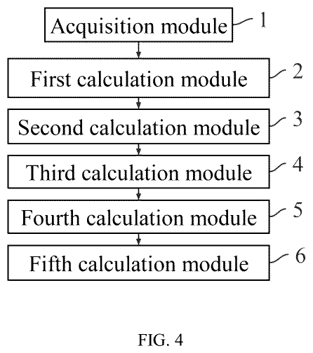

FIG. 4 is a block diagram of a device for calculating a mudding boundary elevation of a headland beach adjacent to a muddy seabed according to an exemplary embodiment.

With reference to FIG. 4, the device includes:
an acquisition module 1 used for obtaining tidal level data, wave data, beach width data and beach height data of the headland beach adjacent to the muddy seabed;
a first calculation module 2 used for calculating a mean high water spring of the headland beach according to the tidal level data;
a second calculation module 3 used for a mean low water spring according to the tidal level data;
a third calculation module 4 used for calculating a wave height according to the wave data;
a fourth calculation module 5 used for calculating a beach slope according to the beach width data and the beach height data; and
a fifth calculation module 6 used for calculating a mudding boundary elevation of a beach according to the mean high water spring, the mean low water spring, the wave height and the beach slope, and a calculation formula is as follows:

$${H}_{sm} = \frac{{H}_{MHWS} + {H}_{MLWS}}{2} - 0.884 {H}^{1.095} {i}^{- 0.275} - 1.589$$

where Hₛₘ is the mudding boundary elevation of the beach, H_{MHWS} is the mean high water spring, H_{MLWS} is the mean low water spring, H is the wave height, and i is the beach slope.

With regard to the device in the above embodiment, a specific way in which each module performs operations has been described in detail in the embodiment of the method, and will not be described in detail here.

For the device embodiment, because it basically corresponds to the method embodiment, it is only necessary to refer to part of the description of the method embodiment for relevant points. The device embodiment described above is only schematic, in which the units described as separate components may or may not be physically separated, and the components displayed as units may or may not be physical units, that is, the components may be located in one place or distributed to multiple network units. Some or all of the modules may be selected according to the actual needs to achieve the purpose of the scheme of the disclosure. Ordinary technicians in this field may understand and implement the scheme without creative labor.

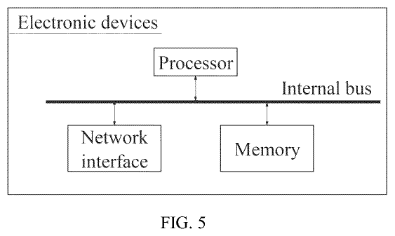

Correspondingly, the disclosure also provides an electronic device, including one or more processors; and a memory for storing one or more programs. When the one or more programs are executed by the one or more processors, the one or more processors may realize the method for calculating the mudding boundary elevation of the headland beach adjacent to the muddy seabed as described above. As shown in FIG. 5, it is a hardware structure diagram of any equipment with data processing capability where the device for calculating the mudding boundary elevation of the headland beach adjacent to the muddy seabed provided by the embodiment of the disclosure is located. In addition to the processor, memory, Direct Memory Access (DMA) controller, disk and nonvolatile memory shown in FIG. 5, any equipment with data processing capability where the device of the embodiment is located usually includes other hardware according to the actual function of the equipment with data processing capability, which will not be described here again.

Correspondingly, the disclosure also provides a computer-readable storage medium, on which computer instructions are stored, where the instructions, when executed by a processor, realize the above-mentioned method for calculating the mudding boundary elevation of the headland beach adjacent to the muddy seabed. The computer-readable storage medium may be an internal storage unit of any device with data processing capability as described in any of the previous embodiments, such as a hard disk or a memory. The computer-readable storage medium may also be an external storage device of the wind turbine, such as a plug-in hard disk, Smart Media Card (SMC), SD card, Flash Card, etc. provided on the device. Further, the computer-readable storage medium may also include both internal storage units and external storage devices of any device with data processing capability. The computer-readable storage medium may be used for storing computer programs and other programs and data required by any equipment with data processing capability, and may also be used for temporarily storing data that has been output or will be output.

Other implementation schemes of the disclosure will easily occur to those skilled in the art after considering the specification and practicing the disclosure herein. This disclosure is intended to cover any variations, uses or adaptations of this disclosure, which follow the general principles of this disclosure and include common sense or common technical means in this technical field that are not disclosed in this disclosure. The specification and embodiments are to be regarded as exemplary only, with the true scope and spirit of the disclosure being indicated by the claims.

It should be understood that this disclosure is not limited to the precise structure described above and shown in the drawings, and various modifications and changes may be made without departing from its scope. The scope of this disclosure is limited only by the appended claims.

1. A method for calculating a mudding boundary elevation of a headland beach adjacent to a muddy seabed, comprising:
a processor configured for:
obtaining tidal level data, wave data, beach width data and beach height data of the headland beach adjacent to the muddy seabed, wherein
obtaining the tidal level data of the headland beach adjacent to the muddy seabed comprises:
when there is long-term measured tidal level series data at the front of the headland beach, using measured tidal level series directly for a statistical calculation to obtain the tidal level data;
when there is no measured tidal level series data, using long-term measured tidal level series data of an adjacent tide station or short-term measured data for the statistical calculation to obtain the tidal level data;
calculating a mean low water spring of the headland beach according to the tidal level data;
calculating a wave height according to the wave data;
calculating a beach slope of the headland beach according to the beach width data and the beach height data, wherein the beach slope is characterized by tidal power, wave power and sediment particle size, and the beach width data and the beach height data may be directly calculated to obtain the slope, based on characterization of overall scale and scale of the headland beach; and
calculating a mudding boundary elevation of a beach according to the mean high water spring, the mean low water spring, the wave height and the beach slope, wherein a calculation formula is as follows:
$${H}_{sm} = \frac{{H}_{MHWS} + {H}_{MLWS}}{2} - 0.884 {H}^{1.095} {i}^{- 0.275} - 1.589$$
wherein Hₛₘ is the mudding boundary elevation of the beach, H_{MHWS} is the mean high water spring, H_{MLWS} is the mean low water spring, H is the wave height, and i is the beach slope;
wherein, calculating the mean high water spring of the headland beach according to the tidal level data comprises:
according to the tidal level data, selecting high tidal levels during an astronomical tide period, wherein the tidal level data is selected from tidal level data of a tide station for at least one whole year, and the astronomical tide period is six days from a second day to a fourth day and from a sixteenth day to an eighteenth day of a lunar calendar; and
calculating an arithmetic mean of the high tidal levels to obtain the mean high water spring;
wherein, calculating the mean low water spring according to the tidal level data comprises:
according to the tidal level data, selecting low tidal levels during the astronomical tide period, wherein the tidal level data is selected from the tidal level data of the tide station for at least one whole year, and the astronomical tide period is the six days from the second day to the fourth day and from the sixteenth day to the eighteenth day of the lunar calendar; and
calculating an arithmetic mean of the low tidal levels to obtain the mean low water spring;
wherein, calculating the wave height according to the wave data comprises:
according to the wave data, observing waves at every hour with no less than 100 waves each time, and sorting wave height series observed at an hour, wherein the wave data is selected from measured wave series at a front of the headland beach or at a nearby wave station for at least one whole year; and
calculating an arithmetic mean of several top wave height series to obtain the wave height.

2. (canceled)

3. The method according to claim 1, wherein obtaining the wave data of the headland beach adjacent to the muddy seabed comprises:
when there is long-term measured wave series data at the front of the headland beach, using measured wave series directly for a statistical calculation to obtain the wave data;
when there is no measured wave series data, using measured wave series data of an adjacent wave station or short-term measured data for the statistical calculation to obtain the wave data.

4. The method according to claim 1, wherein calculating the beach slope according to the beach width data and the beach height data comprises:
a calculation formula of the beach slope i is:
$$i = h / b$$
wherein a beach width b is a length from a back boundary of the beach to an intersection of the beach and a mudflat, and a beach height h is a difference of two topographic elevations.

5. A device for calculating a mudding boundary elevation of a headland beach adjacent to a muddy seabed, comprising:
a processor having:
an acquisition unit used for obtaining tidal level data, wave data, beach width data, and beach height data of the headland beach adjacent to the muddy seabed, wherein
obtaining the tidal level data of the headland beach adjacent to the muddy seabed comprises:
when there is long-term measured tidal level series data at the front of the headland beach, using measured tidal level series directly for a statistical calculation to obtain the tidal level data;
when there is no measured tidal level series data, using long-term measured tidal level series data of an adjacent tide station or short-term measured data for the statistical calculation to obtain the tidal level data;
a first calculation unit used for calculating a mean high water spring of the headland beach according to the tidal level data;
a second calculation unit used for a mean low water spring according to the tidal level data;
a third calculation unit used for calculating a wave height according to the wave data;
a fourth calculation unit used for calculating a beach slope according to the beach width data and the beach height data, wherein the beach slope is characterized by tidal power, wave power and sediment particle size, and the beach width data and the beach height data may be directly calculated to obtain the slope, based on characterization of overall scale and scale of the headland beach; and
a fifth calculation unit used for calculating a mudding boundary elevation of a beach according to the mean high water spring, the mean low water spring, the wave height and the beach slope, wherein a calculation formula is as follows:
$${H}_{sm} = \frac{{H}_{MHWS} + {H}_{MLWS}}{2} - 0.884 {H}^{1.095} {i}^{- 0.275} - 1.589$$
wherein Hₛₘ is the mudding boundary elevation of the beach, H_{MHWS} is the mean high water spring, H_{MLWS} is the mean low water spring, H is the wave height, and i is the beach slope;
wherein, calculating the mean high water spring of the headland beach according to the tidal level data comprises:
according to the tidal level data, selecting high tidal levels during an astronomical tide period, wherein the tidal level data is selected from tidal level data of a tide station for at least one whole year, and the astronomical tide period is six days from a second day to a fourth day and from a sixteenth day to an eighteenth day of a lunar calendar; and
calculating an arithmetic mean of the high tidal levels to obtain the mean high water spring;
wherein, calculating the mean low water spring according to the tidal level data comprises:
according to the tidal level data, selecting low tidal levels during the astronomical tide period, wherein the tidal level data is selected from the tidal level data of the tide station for at least one whole year, and the astronomical tide period is the six days from the second day to the fourth day and from the sixteenth day to the eighteenth day of the lunar calendar; and
calculating an arithmetic mean of the low tidal levels to obtain the mean low water spring;
wherein, calculating the wave height according to the wave data comprises:
according to the wave data, observing waves at every hour with no less than 100 waves each time, and sorting wave height series observed at an hour, wherein the wave data is selected from measured wave series at a front of the headland beach or at a nearby wave station for at least one whole year; and
calculating an arithmetic mean of several top wave height series to obtain the wave height.

6. An electronic device, comprising:
one or more processors; and
a memory for storing one or more programs;
when the one or more programs are executed by the one or more processors, the one or more processors are caused to realize the method according to claim 1.

7. A non-transitory computer-readable storage medium having computer instructions stored thereon, wherein steps of the method according to claim 1 are realized when the instructions are executed by a processor.
